(19) United States
(12) Patent Application Publication
(10) Pub. No.: US 2026/0312967 A1
(43) Pub. Date: Oct. 8, 2026

(54) SYSTEMS AND METHODS FOR PROTECTION OF SECURITY AND PRIVACY THROUGH CONTEXTUAL DATA DISCOVERY

(71) Applicant: TEACHERS INSURANCE AND ANNUITY ASSOCIATION OF AMERICA, New York, NY (US)

(72) Inventors: Sheikh Javed Alam, Bangalore (IN); A M Aysha Nahan, Kochi (IN); Cory Alan Hefner, Charlotte, NC (US)

(21) Appl. No.: 19/169,537

(22) Filed: Apr. 3, 2025

(51) Int. Cl. H04L 9/40; G06F 21/62; H04L 41/16

(52) U.S. Cl. CPC H04L 63/1425; G06F 21/6245; H04L 41/16

(57) ABSTRACT

The following generally relates to systems and methods for protecting the privacy and security of sensitive data on a network. In some embodiments, one or more processors receive an indication of transmission of a network packet by a node on the network, extract data from a data payload contained in the network packet as text, contextualize the data payload using a machine learning model to determine if the data payload poses a data privacy and security risk, and perform a data security procedure in response to determining that the data payload poses a data privacy and security risk. In some embodiments, the data security procedure includes redacting sensitive data from the data payload, identifying the node that transmitted the network packet, and blocking the node from transmitting further packets.

### FIELD OF THE INVENTION

The present disclosure generally relates to protecting data privacy and security and, more specifically, systems and methods for the protection of data security and privacy in a network using contextual data discovery.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

A cybersecurity problem that organizations often face is the monitoring and protection of sensitive data, such as confidential client information, trade secrets, or personally identifiable information (PII), sometimes referred to as data leakage prevention (DLP). Conventional techniques for monitoring and protecting sensitive data generally detect sensitive data by establishing a complicated set of rules, filters, or algorithms, which may be resource and/or time intensive. However, such conventional techniques generally lack the capability to contextually determine if data is sensitive or not. For example, a series of numbers may not be sensitive if the numbers represent a phone number but may be extremely sensitive if the numbers represent a social security number. As another example, a phone number may not be sensitive when transmitted between two employees of an organization but may be sensitive when sent to an unsecure website.

Continuously scanning a large pool of data to monitor and/or protect the security of any sensitive data using a rules-based algorithm is often computationally prohibitive, particularly for organizations (e.g., companies, law firms, government agencies, etc.) with large quantities of data to monitor. Moreover, a rule-based algorithm or similar approach may be inaccurate, especially when dealing with edge cases. The shortcomings of conventional techniques are exacerbated by the fact data owned by an organization is rarely static, data is constantly added, modified, or removed, and each change poses a risk for unauthorized viewing, sharing, and/or copying of sensitive data. Consequently, using conventional techniques, organizations lack the resources to constantly monitor a pool of data, posing a serious data privacy and security risk.

Conventional techniques for monitoring sensitive data may contain access rules to prevent access to sensitive data but generally lack effective solutions to prevent transmission and sharing of sensitive data after the sensitive data is accessed. Additionally, complicated access rules can increase the number of communications, or handshakes, between an individual and a data storage module, increasing the computational resources and time required. Moreover, an individual attempting to share sensitive data may not even be aware the data contains sensitive data or that an intended recipient of the data is not authorized to access such sensitive data. As such, the individual may continue to inadvertently share the sensitive data, allowing unauthorized access to sensitive data.

The systems and methods disclosed herein provide solutions to these problems and may provide solutions to the ineffectiveness, insecurities, difficulties, inefficiencies, and/or other drawbacks of conventional techniques.

### SUMMARY

The present embodiments disclosed herein generally relate to, inter alia, protection of data security and privacy using contextual data discovery. For example, in an interconnected network of users and data, the disclosed systems and methods disclosed herein may be implemented to protect the security and privacy of sensitive data on the interconnected network. In one aspect, a computer-implemented method for protecting data privacy and security in a network maybe be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one aspect, the method may include: (1) receiving, via one or more processors, an indication of transmission of a network packet by a node on the network; (2) extracting, by the one or more processors, a data payload contained in the network packet as text; (3) contextualizing, by the one or more processors, and using a machine learning model, the extracted text to determine if the data payload poses a data privacy and security risk; and (4) in response to determining that the data payload poses a data privacy and security risk, performing, by the one or more processors, a data security procedure, the data security procedure including: redacting sensitive data from the data payload, identifying the node that transmitted the network packet; and blocking the node from transmitting further packets. The method may include additional, fewer, or alternate actions, including those discussed elsewhere herein.

In another aspect, a computing system configured to protect data privacy and security in a network maybe be provided. The computing system may include one or more local or remote processors, sensors, transceivers, servers, memory units, augmented reality glasses or headsets, extended or virtual reality headsets, smart glasses or watches, wearables, and/or other electronic or electrical components. In one aspect, the computing system may include: one or more processors, and one or more memories having stored thereon a set of computer-executable instructions that, when executed, cause the system to: (1) receive an indication of transmission of a network packet by a node on the network; (2) extract a data payload contained in the network packet as text; (3) contextualize the extracted text using a machine learning model to determine if the data payload poses a data privacy and security risk; and (4) in response to determining that the data payload poses a data privacy and security risk, performing a data security procedure, the data security procedure including: redact sensitive data from the data payload, identify the node that transmitted the network packet; and block the node from transmitting further packets. The computing system may include additional, fewer, or alternate elements, including those discussed elsewhere herein.

In yet another aspect, a non-transitory computer-readable medium storing processor-executable instructions that protect data privacy and security in a network maybe be provided. The non-transitory computer-readable medium may include, but is not limited to, volatile or non-volatile memory, optical or magnetic storage, flash memory, solid-state storage, or any other type of storage device capable of retaining computer-readable instructions. In one aspect, when the processor-executable instructions are executed by one or more local or remote processors, the instructions cause the processor to: (1) receive an indication of transmission of a network packet by a node on the network; (2) extract a data payload contained in the network packet as text; (3) contextualize the extracted text using a machine learning model to determine if the data payload poses a data privacy and security risk; and (4) in response to determining that the data payload poses a data privacy and security risk, performing a data security procedure, the data security procedure including: redact sensitive data from the data payload, identify the node on the network that transmitted the network packet; and block the node from transmitting further packets. The non-transitory computer-readable medium storing processor-executable instructions may include additional, fewer, or alternate instructions, including those discussed elsewhere herein.

Additional, alternate and/or fewer actions, steps, features and/or functionality may be included in some aspects and/or embodiments, including those described elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computing environment for protecting data privacy and security in a network through contextual data discovery, according to one embodiment.

FIG. 2 depicts an exemplary block diagram for protecting data privacy and security in a network through contextual data discovery, in accordance with various embodiments.

FIG. 3 depicts an exemplary signal diagram for protecting data privacy and security in a network through contextual data discovery, in accordance with various embodiments.

FIG. 4 depicts an exemplary method for protecting data privacy and security in a network through contextual data discovery.

FIG. 5 depicts an exemplary method for contextualizing data.

FIG. 6 depicts an exemplary method for performing a data security procedure.

FIG. 7A depicts an exemplary block diagram of an example method for training a machine learning model, in accordance with various embodiments.

FIG. 7B depicts an exemplary table of historical data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The systems and methods disclosed herein relate to protection of data security and privacy on a network using contextual data discovery.

As used herein, the term machine learning (ML) model may refer to a computational model trained on data to recognize patterns, make predictions, or perform classification, regression, clustering, or other inference tasks. The machine learning model may include, but is not limited to, artificial neural networks, decision trees, support vector machines, probabilistic models, ensemble learning models, or deep learning architectures such as convolutional neural networks (CNNs) or recurrent neural networks (RNNs).

In some embodiments, the machine learning model may be stored in a non-transitory computer-readable medium and executed by one or more processors. The model may be continuously updated or retrained based upon real-time or batch data to refine predictive capabilities of the model.

The machine model may also refer to models such as, but not limited to, artificial intelligence (AI) models, recurrent neural networks, generative adversarial networks, and/or other such models that can perform tasks which traditionally require human intelligence, for example learning, reasoning, problem-solving, perception, language understanding, generating content, etc. Accordingly, “artificial intelligence” and/or “AI” may be used interchangeably with “machine learning,” “ML,” and/or terminology for similar technologies.

In some embodiments, the machine learning model may be used, for example, to contextualize a data payload of a network packet to determine if the network packet contains sensitive data, and categorize the data payload by levels of sensitivity, thereby providing an improvement to the technological field of data privacy as compared to non-generative AI techniques. In particular, generative AI techniques consider contextual information, thereby improving responsiveness and accuracy of the model and enabling the model to iterate on responses, saving computing resources and processing time.

As used herein, the term large language model (LLM) may refer to machine learning model(s) trained on a large corpus of text data to perform tasks associated with natural language processing (NLP), such as text generation, translation, summarization, classification, question answering, and contextual understanding. The large language model may be based upon deep learning architectures, including but not limited to transformer-based neural networks, such as Bidirectional Encoder Representations from Transformers (BERT), Generative Pre-trained Transformer (GPT), or other attention-based models.

The large language model may be trained using supervised learning, unsupervised learning, self-supervised learning, reinforcement learning, or a combination thereof. Training the large language model may include processing large quantities of text data to learn statistical patterns, relationships between words, and contextual representations, in some embodiments leveraging tokenization, embeddings, and attention mechanisms to generate coherent and contextually relevant outputs.

In some embodiments, a large language model may be used, for example, to contextualize a data payload of a network packet to determine if the network packet contains sensitive data. Additionally, the large language model may be used to summarize a data payload and/or generate additional text relating to a data payload.

In some embodiments, any artificial intelligence model, machine learning model, and/or large language model as described herein may be stored in a non-transitory computer-readable medium and executed by one or more processors. The model may be fine-tuned on domain-specific data or adapted for real-time inference, personalization, or continual learning based upon user interactions and/or additional training data. In further embodiments, any model may be hosted on a network, either locally or remotely. Any model may additionally or alternatively be hosted on the cloud or in a cloud computing server.

In some embodiments, the systems and methods disclosed herein are intended to improve the privacy and security of sensitive data on a network. For example, an organization, and members of the organization, may have access to sensitive data, and the privacy and security of the sensitive data may need to be protected. The systems and methods disclosed herein may enable such an organization to effectively monitor any sensitive data and protect the security and privacy of such sensitive data.

Moreover, the systems and methods disclosed herein offer numerous benefits. For example, the systems and methods disclosed herein provide an efficient method of detecting sensitive data and protecting the privacy of any detected sensitive data. By using a machine learning model to analyze and contextualize data, the systems and methods can automatically, more accurately, and more efficiently detect sensitive data compared to conventional techniques. The automated response to the detection of sensitive data enables a system to more quickly and automatically protect the security and privacy of sensitive data and, importantly, prevent further incidents of sensitive data pilferage. The instant techniques therefore improve the security of sensitive data in a network and offer improvements over conventional methods for protecting the security of sensitive data in a network.

The systems and methods disclosed herein also provide a solution that enables dynamic detection and contextualization of sensitive data. By analyzing data payloads of transmitted network packets, the systems and methods overcome limitations of conventional techniques that require all data in a network or organization to be analyzed each time data is added, modified or removed. The systems and methods are more efficient and require less computing time and resources compared to conventional techniques, as the analyzing is performed when data is transmitted and/or attempted to be transmitted across a network. It should be appreciated that other benefits are envisioned.

### Example Computing Environment

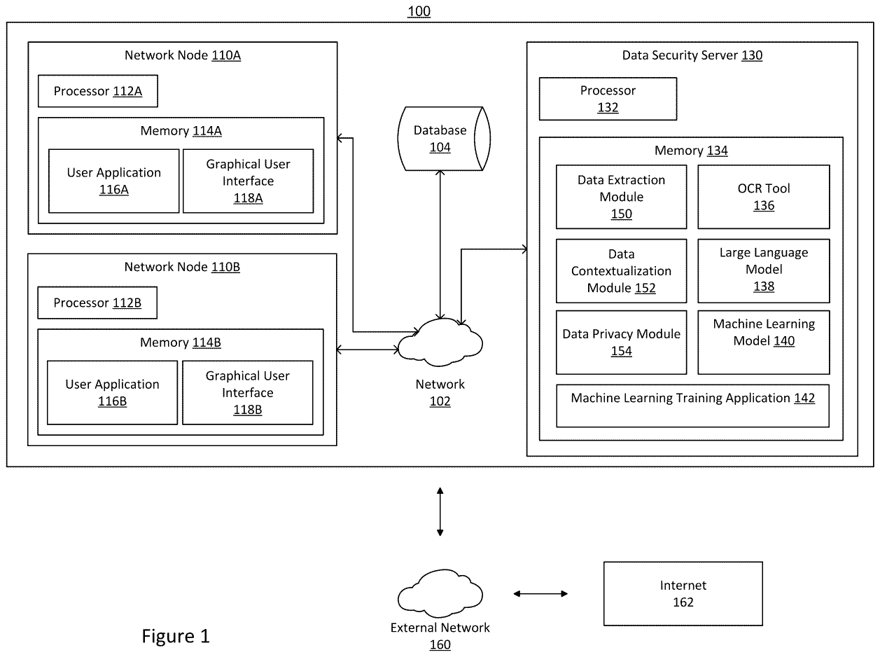

FIG. 1 depicts a computing environment 100 for protecting data privacy and security in a network through contextual data discovery, according to one embodiment. The high-level architecture includes both hardware and software applications, as well as various data communication channels for communicating data between the various hardware and software components.

The computing environment 100 may include, in some embodiments, a network 102, a database 104, network nodes 110A-B, and a data security server 130. Each of the database 104, network nodes 110A-B, and the data security server 130 may be communicatively connected to the network 102 as described below. It should be understood that the example computing environment 100 may include additional, fewer, and/or alternate components.

In some embodiments, the database 104 may be a data storage system configured to store, manage, and/or retrieve structured or unstructured data that can be accessed by various network nodes via the network 102. The database may be implemented as a relational database, NoSQL database, graph database, and/or other data management system and may reside on a local server, cloud-based infrastructure, edge-computing infrastructure, and/or a distributed computing environment. In some embodiments, the database communicates with networked devices, including user terminals, application servers, and/or external data sources, using structured query language (SQL), application programming interfaces (APIs), and/or other data access protocols. Security mechanisms such as authentication, encryption, and/or access control policies may be employed to protect data from unauthorized access. Additionally, the database may support data replication, indexing, and/or backup operations to ensure high availability, fault tolerance, and efficient data retrieval across networked systems.

The network node 110A will be discussed in detail, although it should be understood that the network node 110B may be a similar element of the computing environment 100, or the network node 110B may include additional, fewer, and/or alternate components. In some embodiments, the network node 110A may include processor 112A, which may be or include one or more processors, such as central processing units (CPUs), graphics processing units (GPUs), and/or any other suitable processor, microprocessor, or controller. The processor 112A may be communicatively coupled to and/or otherwise accessed by a memory 114A via a computer bus (not depicted) to create, read, update, transmit, delete, or otherwise access or interact with the data, data packets, or otherwise electronic signals to and from the processor 112A and the memory 114A. Additionally or alternatively, computer-readable instructions may be stored on the memory 114A which may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc.

The memory 114A stores machine-readable instructions executable by the processor 112A, that when executed, may run a user application 116A, such as an operating system (e.g., Microsoft Windows, Linux, UNIX, DOS, Android, iOS, etc.) capable of facilitating the functionalities, applications, methods, or other software. The memory 114A may also store machine-readable instructions to run a graphical user interface (GUI) 118A. The graphical user interface 118A may enable a human user to interact with network node 110A using an output device (e.g., monitor, television, projector, etc.), and/or an input device (e.g., mouse, keyboard, trackpad, touch screen, eye-tracking device, etc.). The network node 110A may contain additional hardware (not pictured), or machine-readable instructions stored in memory 114A, to facilitate communication with the network 102.

In some embodiments, the network node 110A may be a network node associated with a user. For example, the network node 110A may be a personal computer belonging to a user. The user may be a part of the organization associated with the network 102. In some embodiments, the network node 110A may be any device capable of communicating with the network 102, such as, but not limited to, a database, a server, a virtual reality (VR) or augmented reality (AR) device, or an Internet-of-Things (IoT) device.

In some embodiments, the database 104, network nodes 110A-B, and data security server 130 are communicatively connected to an external network 160 using the network 102 as a gateway. Additionally or alternatively, the database 104, network nodes 110A-B, and data security server 130 can be configured to communicate with the internet 162 via external network 160. Connectivity to the internet 162 may be established through various communication protocols, including Hypertext Transfer Protocol Secure (HTTPS), Transmission Control Protocol/Internet Protocol (TCP/IP), Secure Shell (SSH), and Virtual Private Network (VPN) tunneling.

In some embodiments, the network 102 may access cloud-based platforms, third-party databases, web services, or external application programming interfaces (APIs) to retrieve, transmit, or synchronize data from the internet162. The network 102 may also facilitate access to the internet 162 through remote login mechanisms, such as Secure Socket Layer (SSL) encrypted connections, multi-factor authentication (MFA), or single sign-on (SSO) authentication frameworks. In order to manage inbound and outbound data traffic, the network 102 may implement network address translation (NAT), proxy servers, and/or content filtering mechanisms.

The data security server 130 may be a network node communicatively connected to the network 102 that includes a processor 132, which may include one or more central processing units (CPUs), graphics processing units (GPUs), and/or any other suitable processor, microprocessor, or controller. The data security server 130 may also include a processor 132 and a memory 134. The memory 134 may be communicatively coupled to and/or otherwise accessed via a computer bus (not depicted) to create, read, update, transmit, delete, or otherwise access or interact with the data, data packets, or otherwise electronic signals to and from the processor 132. Additionally or alternatively, computer-readable instructions may be stored on the memory 134. The computer-readable instructions may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc.

In some embodiments, the network 102 may be a Local Area Network (LAN), and each component communicatively connected to the network may be connected via wired connections (e.g., Ethernet) or wireless protocols (e.g., Wi-Fi). Alternatively, the network 102 may be a Wide Area Network (WAN), a cellular network, or any other appropriate network to connect multiple network-enabled devices. In some embodiments, the network 102, the database 104, network nodes 110A-B, and the data security server 130 may be operated by, and/or associated with a company, business or organization, etc. (collectively “organization”). The elements communicatively connected to the network 102 may be collectively referred to as an “internal network,” and may be associated with the organization.

Generally speaking, in computing environment 100, nodes connected to network 102, such as network node 110A, communicate with other nodes on the network 102 and/or with the external network 160. The communication occurs when one node transmits network packets (e.g., Wi-Fi packets, Ethernet packets, LTE packets, etc.) to at least one or more other nodes via the network 102 and/or the external network 160. It should be understood that the network 102 may contain additional hardware and/or software components (that are not pictured) to facilitate the transmission of network packets between nodes. Exemplary hardware components may include servers, switches, or routers etc. Exemplary software components may include Dynamic Host Configuration Protocol (DHCP), Address Resolution Protocol (ARP), or Transmission Control Protocol (TCP), etc. For example, if a user wants to retrieve data from a webpage, the user can use network node 110A to send and receive packets from the internet 162, via the external network 160 and the network 102.

In some embodiments, the data security server 130 may analyze a data payload contained in a network packet transmitted from a node connected to the network 102. The data security server 130 and its various sub-components may extract the data from the payload, contextualize the data payload, and take actions to protect the privacy and security of the data. For example, a user corresponding to the network node 110A may want to send an email to a user corresponding to network node 110B. The network node 110A may then transmit a network packet to the network node 110B on network 102. The data payload of the network packet may contain the email body and any attachments, both of which may contain sensitive data. In some embodiments, the network 102 may be an internal network or a combination of an internal and external network. In further embodiments, the network node 110B may be accessible only via an external network, such as the external network 160 or the internet 162, and/or a combination of internal and external networks.

The data security server 130 may contain hardware and software components to facilitate the protection of privacy and security of sensitive data. The memory 134 may store machine-readable instructions that, when executed by the processor 132, may cause the data security server 130 to execute an OCR tool 136, a large language model 138 (LLM), a machine learning model 140, and/or a machine learning training application 142. The memory 134 also contains the following modules: a data extraction module 150, a data contextualization module 152, and a data privacy module 154. The above-referenced modules may represent different areas of memory 134 to perform some of the methods described herein but may also be used solely for illustrative purposes to assist in describing and compartmentalizing some of the methods described herein that may be performed by the data security server 130. It should be understood that any methods attributed to a specific sub-module described in this present disclosure may be performed by at least any of the data security server 130, the data extraction module 150, the data contextualization module 152, and/or the data privacy module 154.

In some embodiments, the data security server 130 may receive an indication from a network node that the network node is transmitting a network packet on the network 102. The data security server 130 may then proceed to analyze the network packet to contextualize data contained in the network packet. In further embodiments, the data security server 130 may act as a gateway on the network 102 and intercept all network packets transmitted across the network 102 and therefore may automatically analyze network packets without receiving an indication. In yet further embodiments, the data security server 130 may analyze all network packets transmitted on the network 102.

In some embodiments, analyzing the network packet may at least partially occur at the data extraction module 150. The data extraction module 150 may extract the data from the data payload of the network packet. The data extraction module may also determine a type of data contained in the data payload. In some embodiments, the machine learning model 140 may determine the type of data contained in the data payload. In further embodiments, one or more rules-based algorithms may additionally or alternatively determine the type of data. Based upon the determination, the data extraction module 150 may utilize various software programs and/or hardware components to extract the data contained in the data payload. If the data payload contains text, the data extraction module 150 may, for example, use any appropriate text manipulation software tool to text in the data payload. In some embodiments, text on the data payload may be contained in a proprietary file type and the data extraction module 150 may contain appropriate software applications to extract text from the proprietary file type. The data extraction module 150 may also use the large language model 138 to summarize or otherwise manipulate the extracted data.

The OCR tool 136 may be a software-based system configured to analyze and convert images of text, such as scanned documents, photographs, or handwritten notes, into machine-readable text data. The OCR tool 136 may utilize image processing and/or computer vision techniques (e.g., edge detection, binarization, noise reduction, etc.) to enhance text visibility before applying character recognition algorithms. Additionally or alternatively, the OCR tool 126 may utilize machine learning models and/or artificial intelligence, such as convolutional neural networks (CNNs) or recurrent neural networks (RNNs), to improve text recognition accuracy by learning from diverse fonts, handwriting styles, and document layouts. The OCR tool 126 may support multiple languages and character sets.

In some embodiments, the OCR tool 136 may additionally or alternatively be a hardware-based solution separate from the data extraction module 150 and may communicate with the data extraction module 150 via any suitable wireless or wired communication protocol.

In some embodiments, the large language model 138 may be a general-purpose model (e.g., trained on a wide array of publicly available datasets such as web pages, documents, etc., available via the internet) or may be a domain-specific model (e.g., trained or fine-tuned on custom and/or proprietary datasets). Broadly speaking, a large language model, such as a generative pre-trained transformer LLM, may be capable of performing a wide range of natural language processing tasks, including but not limited to text generation, summarization, translation, question answering, sentiment analysis, and contextual understanding.

In the context of the present disclosure, “using,” “executing,” or “running,” a large language model may refer to inputting a command along with any supplementary inputs to the large language model 138 and/or using the large language model 138 to generate an output. For example, to use the large language model 138 to summarize the contents of a file, a user may input the command, “summarize this file” and include the file as the supplementary input. In some embodiments, the command and the supplementary file can be any appropriate data type, for example, text, image, video, etc.

In further embodiments, the large language model 138 may be used to contextualize a data payload and/or determine if the data payload contains any sensitive data. In some embodiments, the data extraction module 150 may extract data from a data payload as machine-readable text and may transmit the extracted data to the data contextualization module 152. The data contextualization module 152 may then transmit the extracted data as an input to the large language model 138, along with other contextual information. The large language model 138 may then contextualize the data payload.

In some embodiments, the data security server 130 may execute the machine learning training application 142 to train the machine learning model 140. Depending upon the embodiment, the data security server 130 may train the machine learning model 140 by teaching the model an algorithm to predict outputs based upon different inputs. In some embodiments, the machine learning model 140 may be trained to predict a level of sensitivity and an indication of sensitive data based upon different inputs (contents of data, context of data payload, type of data, etc.). The machine learning model 140 may be trained by machine learning training application 142, or another training application using supervised, semi-supervised, or non-supervised learning techniques, using training data of the appropriate modality. Additional details regarding the training process may be found in the present disclosure.

In some embodiments, the machine learning model 140 may be trained to accept input data as machine-readable text or an organized array of machine-readable text (e.g., a table). It should be understood, however, that the machine learning model 140 may be trained to accept any type of data as input. The data extraction module 150 may change the type of data extracted to match the input data type of the machine learning model 140.

Broadly speaking, the data contextualization module 152 may use the machine learning model 140 to determine if a data payload contains sensitive data and if so, identify contents of the sensitive data. In some embodiments, the data extraction module 150 may extract data from a data payload as machine-readable text and may transmit the extracted data to the data contextualization module 152. The data contextualization module 152 may then transmit the extracted data as an input to the machine learning model 140, along with other contextual information. The machine learning model 140 may then determine if the data payload is sensitive and/or includes sensitive data.

More specifically, the machine learning model 140 may determine if the data payload contains sensitive data and categorize the data payload into levels of sensitivity. In some embodiments, the level of sensitivity may include low, medium, and high, where a “high” level of sensitivity may correspond to the data contained in the data payload being highly sensitive or posing a high security and privacy risk. In an organization, a high level of sensitivity may also correspond to highly confidential data. It should be understood that depending upon the embodiment, there may be more or less levels of sensitivity, and the levels may be labeled with different names.

In some embodiments, the levels of sensitivity may be determined based upon user-defined thresholds. In further embodiments, the level of sensitivity may be automatically determined used guidelines of the network. In some embodiments, the machine learning model 140 may be trained to learn the method of determining the level of sensitivity.

It should be understood that the large language model 138 and/or the machine learning model 140 may be pre-trained. That is, the large language model 138 and/or the machine learning model 140 may be trained on generic, readily available data and/or using generic training techniques. In further embodiments, the large language model 138 and/or the machine learning model 140 may be trained by the machine learning training application 142.

Following the categorization of the data payload, the data privacy module 154 may receive an indication of the level of sensitivity of the data. The data privacy module 154 may also receive an indication of a location of the sensitive data in the data payload (e.g., a particular document or portion of a particular document) and a summary of the sensitive data to facilitate taking actions to protect the privacy and security of the sensitive data. In response to receiving the aforementioned indication, the data privacy module 154 may determine a set of recommended responses to adequately protect the privacy and security of any sensitive data.

The data privacy module 154 may also determine whether to deliver the network packet to the one or more intended recipients. The determination may be based upon the level of sensitivity of the data payload and/or other contextual information about the data payload. The determination may be performed by a rules-based algorithm, or by a machine learning model. In some instances, the data privacy module 154 may drop the network packet (e.g., block, quarantine, delete, or otherwise prevent the transfer of) to protect the privacy and security of any sensitive data.

In some embodiments, the computing environment 100 may be hosted in the cloud. That is, the elements of the computing environment 100 may be located in the cloud, for example, on a web server or a cloud computing platform. It should be understood that any processor, memory, application, database and/or network illustrated in FIG. 1, for example, may be implemented in a cloud computing platform. In further embodiments, the computing environment 100 may be an on-premises environment, an edge-computing environment, or some combination thereof.

It should be understood that computing environment 100 may contain additional, fewer, or alternative elements in various embodiments.

### Example Illustrations of Example Methods of Protecting Data Privacy and Security

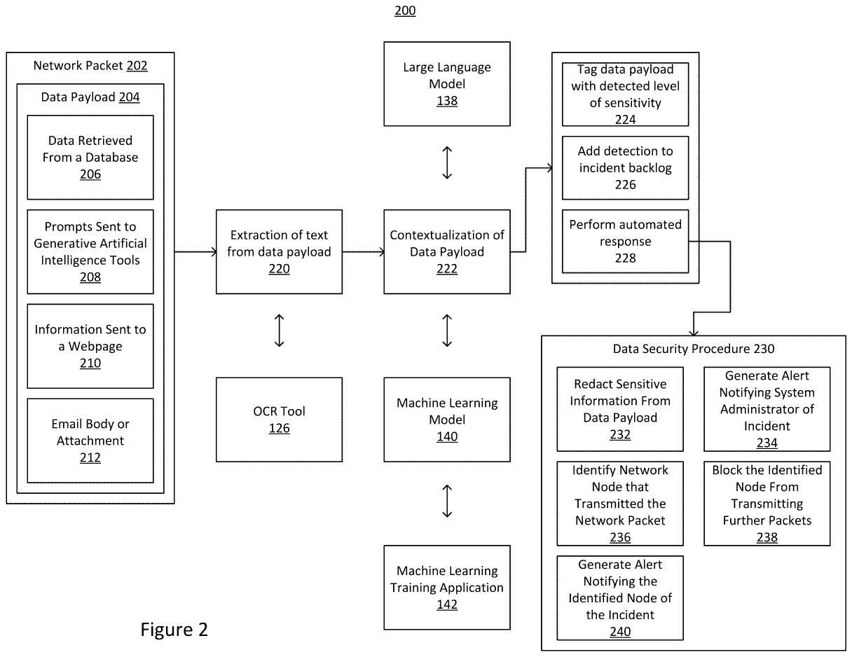

FIG. 2 depicts an exemplary block diagram 200 for protecting data privacy and security in a network through contextual data discovery. The block diagram 200 illustrates a method for protecting the privacy and security of data on a network, according to one embodiment.

The exemplary method depicted in block diagram 200 may start at network packet 202. In some embodiments, a network node communicatively connected to the network 102 may initiate communication with another node by transmitting a network packet, such as the network packet 202. The network packet 202 may be any appropriate type of network packet, such as a Wi-Fi packet, Ethernet packet, LTE packet, depending upon a corresponding network protocol used to transmit the network packet 202.

The network packet 202 may contain a data payload 204. The data payload 204 may contain data corresponding to communication that the network node transmits. As such, the network packet 202 may include other data (metadata, sub-headers, padding, etc.) that facilitates the transmission of the network packet 202 but is not part of the data payload 204. Broadly speaking, data payload 204 can include any type of data, as long as the transmitting and receiving nodes contain the appropriate hardware and/or software to encode and decode the data. Common data formats contained in a data payload may include text, image, or video. Regardless of the data format, the contents of the data payload 204 may originate from various sources on the network 102. Sub-blocks 206-212 show exemplary categories and/or origins of data that may be contained in the data payload 204, including data retrieved from a database, prompts sent to Generative Artificial Intelligence (Gen AI) tools, information sent to a webpage, and email bodies or attachments.

At sub-block 206, data may be retrieved from the database 104, or any database communicatively accessible by a node on the network 102 and transmitted in the data payload 204. The data from the database may be transmitted as raw data, as a pointer (e.g., link) to the location of the data on a database, or an altered form (e.g., compressed data) in the data payload 204.

At sub-block 208, the data payload 204 may contain a prompt in which the intended recipient of the data payload is a Gen AI tool. Such prompts may be text, images, and/or video, or any data type that a Gen AI tool is able to take as input to generate output. The generative AI tool may be accessible via network 102 and/or the internet 162. The generative AI tool may be any appropriate tool, including but not limited to, a large language model, a machine learning model, or an artificial intelligence model.

At sub-block 210, the data payload 204 may contain data intended to be input into a webpage. In some embodiments, the webpage uses Hypertext Transfer Protocol (HTTP) or Hypertext Transfer Protocol Secure (HTTPS), and the data payload 204 contains an HTTP/HTTPS PUT or POST command to send data to a web page and/or web server. The data payload 204 may also contain an HTTP/HTTPS GET command to retrieve data from a web page or web server. However, the data payload 204 may contain any command for any protocol used by a webpage to appropriately send and receive data. The data payload 204 may include text, links, or multimedia (e.g., image, audio, video, etc.) to be sent to a web page or web server. When the recipient web page uses HTTPS, the data payload 204 may be encrypted.

At sub-block 212, the data payload 204 may contain an email body or attachment, which may contain text, multimedia elements, or embedded files that facilitate communication between users over a network. The email body may include plain text, formatted text with hyperlinks, or rich media such as images and embedded objects. In some embodiments, attachments may comprise documents, spreadsheets, images, audio files, or executable files, which are encoded and transmitted along with the email message.

It will be understood that in some embodiments, for example, the data to be analyzed may be on the same device as the computing environment 100. In such embodiments, the packet the data is transmitted on may not be a network packet, but rather another appropriate form of communication within the device. The methods described herein may still apply even if the data payload is contained in another type of packet other than a network packet.

At block 220, data contained in the data payload 204 may be extracted. Generally speaking, the contents of the data payload 204 are extracted as machine-readable text. The extraction step may include using various hardware elements and/or software programs to extract the contents of the data payload 204 as machine-readable text, based upon the format of data in data payload 204.

In some embodiments, the data payload 204 may contain an image or a data type comprising a series of images (e.g., video, Graphics Interchange Format (GIF), etc.). In such embodiments, the data security server may use the OCR tool 126 at block 220. The OCR tool 126 may take the image data as input, and extract any text contained in the image as machine-readable text. For example, if the data contains a screenshot of text, a traditional text manipulation tool may not be able to extract the text contained in the screenshot, but the OCR tool 126 may scan the image file and extract the text.

If the data payload 204 contains data encoded in multiple formats, such as both text and images, a different method or tool may be used to extract data from each of the different formats and later combined into a single body of machine-readable text output. For example, if the data payload contains an email body with an image attachment, the method at block 220 may use a text-manipulation tool or any similar tool to extract the textual portion of the data payload as a first part of the data, and an OCR tool, such as the OCR tool 126, to extract the image portion of the data payload as text as a second part of the data. A text manipulation tool may then be used to combine the first part of the data and the second part of the data into one body of text corresponding to the entire extracted contents of the data payload.

A summary of the contents of the data payload 204 may be generated by the large language model 138. The generated summary may be tagged to the data payload. In some embodiments, tagging a generated summary, data payload, and/or other data set may include assigning labels, metadata, or identifiers to data, files, or other digital objects. For example, the generated summary or any other tags may be added to the network packet 202 as a part of the metadata. The generated summary may be also used in other steps of the methods and/or other elements of the system described in this disclosure. The generated summary may also enable an observing user to more quickly and easily analyze the contents of the data payload 204.

In some embodiments, when there may not be any textual data to extract from the data payload 204, the data payload 204 may be input into a large language model, such as the large language model 138, to generate a summary of the contents of the data payload 204. For example, if a data payload contains an image with no text, the large language model 138 may generate a summary describing contents of the image.

In further embodiments, the data contained in the data payload 204 may be structured or unstructured. It would be understood by one of ordinary skill in the art that the systems and methods of extracting data from the data payload 204 may apply to both structured and unstructured data. In some embodiments where the data is structured, exact data matching (EDM) techniques may be used to monitor sensitive data. An exemplary EDM technique may convert structured data to a unique fingerprint, such as by using data normalization and hashing algorithms.

At block 222, the extracted data from block 220 may be contextualized by the machine learning model 140 and/or the large language model 138. Broadly speaking, contextualizing the data may include analyzing the contents of the data payload 204, along with contextual information of the data payload 204 to determine if the data payload 204 contains sensitive data. Contextual information may include information about the node that transmitted the packet, the type of data contained in the data payload 204, information about the one or more intended recipient nodes of the network packet 202, or the time and date the network packet 202 is transmitted etc. Information about the node that transmitted the packet may include, a user associated with the node, the type of device corresponding to the node, how often the node transmits packets, etc. Analyzing the contextual information about the data payload 204 may enable the method to more accurately determine a level of sensitivity of the data payload 204 because, for example, data may be considered sensitive in some contexts but may not be considered sensitive in others.

At block 222, the machine learning model 140 may be used to perform the contextualization. In response to receiving the data extracted from the data payload 204 and contextual information about the data payload 204, the machine learning model 140 may output an indication of a level of sensitivity of the data payload 204 and/or an indication of any detected sensitive data. The indication of detected sensitive data may include: (i) whether sensitive data was detected, (ii) the contents of the sensitive data, (iii) the type of sensitive data detected, and/or (iv) the location of the sensitive data within the data payload 204 (e.g., a relative location, a page number, a document identifier, etc.).

In some embodiments, the indication of detected sensitive data and/or the level of sensitivity of the data payload may be tagged to the network packet 202. A record of the contextualization process, which may include information about the network packet, the level of sensitivity and/or indication of sensitivity, may also be stored in a database or any other appropriate data storage medium.

In further embodiments, the large language model 138 may be used to perform the contextualization. The large language model 138 may take a prompt including the data extracted from the data payload 204 and any additional contextual information about the data payload 204 to contextualize the data payload. The large language model 138 may indicate whether sensitive data was detected, the contents of the sensitive data, the type of sensitive data detected and/or an indication of a location of the sensitive data within the data payload 204.

Following the contextualization of the data payload 204, the exemplary method of block diagram 200 method may continue to block(s) 224, 226, and/or 228. At block 226, the detection of sensitive data in the data payload 204 may be added to an incident backlog. The incident backlog may be a list, queue, array, or any appropriate data structure for storing historical incidents of sensitive data detection. In some embodiments, the incident backlog may be a first-in, first-out (FIFO) queue. When an incident is added to the incident backlog, details about the incident may be included, such as, a timestamp corresponding to when the incident occurred, information about the network packet 202 and data payload 204, and any other relevant contextual information.

At block 228, an automated response may be performed in response to the contextualization of the data payload. Generally speaking, the automated response may take appropriate action to protect the privacy and security of any detected sensitive data. In some embodiments, the automated response may be a data security procedure 230. In response to a high level of sensitivity determination, data security procedure 230 may be performed.

In some embodiments, when an incident is added to the incident backlog, the machine learning model 140 can perform an incident management routine that automatically assigns the incident as one of, escalation, attestation, or dismissal. Depending upon the contextualization of the data payload, the incident management routine determines how to assign the incident. If an incident is assigned as dismissal, the incident management routine may log or store a record of the incident and automatically dismiss the incident from the backlog. If an incident is assigned as attestation, a user associated with the network node that transmitted the network packet containing the data payload may be notified. If an incident is assigned as escalation, the incident management routine may automatically notify an authorized party, such as a system administrator, to further investigate the incident. The machine learning model 140 may notify an appropriate party using any combination of systems and methods of generating an alert as disclosed herein.

The data security procedure 230 may include multiple actions, examples of which are depicted in sub-blocks 232-240. At sub-block 232, any detected sensitive data may be redacted from the data payload 204. In general, the redacting method may include any steps such that the detected sensitive data in data payload 204 is no longer accessible, for example, obfuscating or removing the detected sensitive data. Based upon the type of data contained in the data payload 204, steps taken to redact the sensitive data may vary. In some embodiments, the data payload 204 contains only data stored as text, and the redacting method may run an appropriate software application to edit the text in the data payload 204 to delete the sections of the data payload 204 containing sensitive data. The redacting method may determine which parts of the data payload 204 contain sensitive data based upon the indication received from the machine learning model 140.

At sub-block 232 of block diagram 200, the redacting step may also replace any redacted sensitive information with placeholder data corresponding to the deleted data. For example, the machine learning model 140 may determine that the sensitive data is a phone number. Accordingly, the redacting method may delete the phone number from the data payload and replace the deleted phone number with text stating “redacted phone number.” The redacting method may rely on pre-determined phrases for replacing redacted sensitive data or may use the large language model 138 to generate appropriate replacement text. Additionally, if the data payload contains sensitive data that is stored in a format other than text, the data security server 130 may take appropriate actions to redact any sensitive data. For example, if the data payload contains an image with sensitive data, the data security server 130 may edit the image to place a solid black box covering the sensitive data.

At sub-block 234, the data security procedure 230 may generate an alert notifying a system administrator. A system administrator may be any user that performs duties to monitor the network 102. The system administrator may also perform duties to protect the privacy and security of data on the network 102. The generated alert may notify the system administrator of the indication of detected sensitive data in the data payload 204. In response to receiving the generated alert, the system administrator may take further actions to protect the privacy and security of the detected sensitive data.

At sub-block 236, the node on the network 102 that transmitted the network packet 202 containing the data payload 204, may be identified. The identified network node may be referred to as an “origin node.” The origin node may be identified by a corresponding Internet Protocol (IP) address. Generally speaking, an IP address may be a numerical identifier assigned to a device connected to a network, enabling communication and data exchange over the internet or a local network. An IP address may be used to route network packets, identify network nodes, and enforce security policies, such as access control and authentication. IP addresses may be static (i.e., remaining fixed for a device) or dynamic (i.e., changing periodically through assignment by a Dynamic Host Configuration Protocol (DHCP) server). In general, at any given time on a network, such as the network 102, each node connected to the network may be assigned a unique IP address, and accordingly, each network node can be identified by the corresponding assigned IP address.

The origin node may also be identified by an assigned Media Access Control (MAC) address. A MAC address may be a unique numerical identifier assigned to a network-capable device at the time of manufacture. As such, a MAC address may be static and unique to each network-capable device.

In some embodiments, the metadata of the network packet 202 may be analyzed to determine the IP address of the node that transmitted the packet. A DHCP server, which may assign IP addresses to nodes connected to a network server, may be used to determine the MAC address of a node based upon the corresponding IP address. An address resolution protocol (ARP), which may contain a mapping of IP addresses to MAC addresses may also be used to determine the MAC address of the origin node based upon the corresponding IP address. As such, the method at sub-block 236 may use alternative identifiers to identify a network node.

In some embodiments, a user associated with the origin node may be identified. In some instances, the network packet 202 may be analyzed to determine the user. Specifically, a user's information may be included in the metadata of the network packet 202. In other instances, the network 102 may use any database, or look up table, or other appropriate data storage medium, that contains data linking a user to a network node. The user may be identified by a name, an email, an assigned ID number, or any other appropriate identifying information.

Following the identification of the node that transmitted the network packet 202 and/or the user associated with the origin node, the data security procedure 230 at sub-block 238 may block the identified origin node from transmitting further network packets. The blocking method may include analyzing a second network packet transmitted on network 102 to determine the origin node of the second packet. The origin node of the second network packet may be determined in a similar manner to the procedure of sub-block 236. If the origin node of the second packet is the same as the origin node of network packet 202, the blocking method may automatically drop (e.g., block, quarantine, delete, or otherwise prevent transfer of) the second network packet and therefore prevent the delivery of the second packet to one or more indented recipients.

The blocking method may follow a set of rules to determine if or when to stop blocking the origin node from transmitting further network packets. The set of rules may be time-based or may follow a pre-determined algorithm. In some embodiments, a user, such as a system administrator, may be required to manually reenable the origin node to send further network packets. In other embodiments, the user associated with the origin node may be required to take certain actions before the identified node can send further network packets. In yet other embodiments, a machine learning model may be used to determine when the origin node can further transmit network packets.

At sub-block 240, the data security procedure 230 may generate an alert. The generated alert may be directly generated at a network node and/or computing device or transmitted to a user and/or device associated with the user by any other means of communication (e.g., email, text message, phone call, etc.). In some embodiments, in an organization where the user associated with the identified device has one or more managers or direct supervisors, the generated alert may be additionally or alternatively transmitted to the one or more managers and/or direct supervisors. In further embodiments, the alert may be generated directly on a GUI corresponding to the network node that transmitted the network packet 202.

In some embodiments, and after the data security procedure 230, the network packet 202 may be delivered to one or more intended recipients. As such, contents of the network packet 202 apart from any redacted sensitive data may be delivered to one or more intended recipients. Delivering the network packet with sensitive data redacted may enable communication between two network nodes without compromising the security and privacy of the sensitive data. In other embodiments, and after the data security procedure 230, the network 102 may drop (e.g., block, quarantine, delete, or otherwise prevent transfer of) the network packet 202. The contextualization of the data payload may be used to determine whether to deliver or drop the network packet 202. The network 102 may also implement a rules-based algorithm to determine whether to deliver or drop the network packet 202. For example, a rules-based algorithm may determine and/or otherwise cause a device to drop all network packets with intended recipients only accessible by the internet 162 and with a high level of sensitivity.

In some embodiments, not shown in the method illustrated by block diagram 200, the data security procedure 230 may include additional, alternative, or fewer actions. In one such embodiment, for example, in response to a low level of sensitivity detection by the machine learning model 140, the data security procedure 230 may deliver a network packet as intended and not take any further actions. In a further embodiment, for example in response to a medium level of sensitivity detection by the machine learning model 140, the data security procedure 230 procedure may identify and/or redact sensitive data from a network packet following a similar method as sub-block 232 and identify a network node that transmitted the network packet following a similar method as sub-block 236. However, in contrast to sub-block 238, such an embodiment may proceed by refraining from blocking the identified network node from transmitting further packets.

It would be understood by one of ordinary skill in the art that the steps taken at data security procedure 230 protect the privacy and security of sensitive data on network 102. The redaction of sensitive data prevents sharing and unauthorized access to of sensitive data, protecting the security and privacy of such sensitive data. Identifying a computing device or network node that transmitted sensitive data, and preventing the computing device or network node from sending further data, takes proactive steps to prevent further sensitive data from being distributed and/or transmitted.

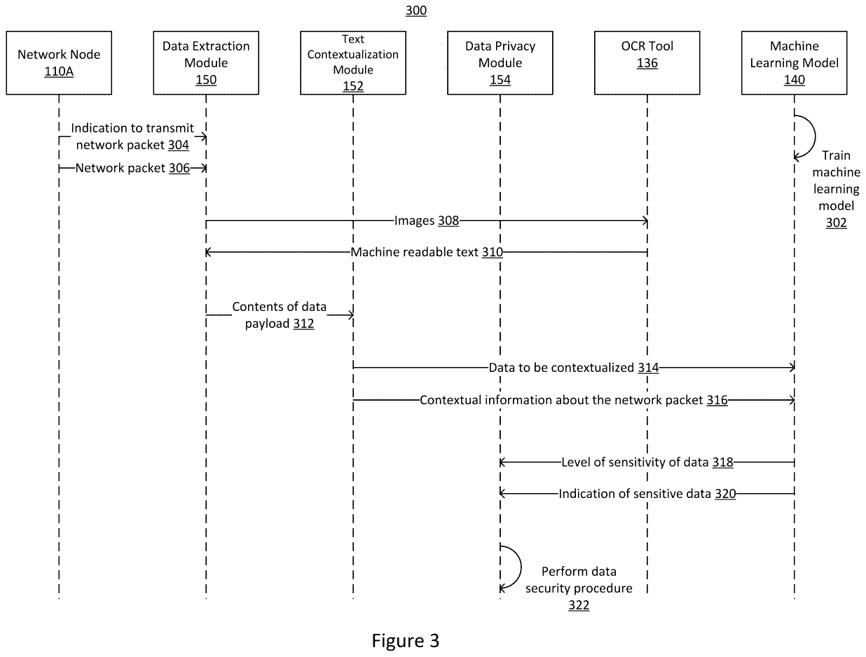

Turning to FIG. 3, an exemplary signal diagram 300 for protecting data privacy and security in a network through contextual data discovery is depicted, in accordance with various embodiments. The signal diagram 300 illustrates the signals exchanged and/or detected by various components of a system for protecting data privacy and security in a network through contextual data discovery, such as the example computing environment 100.

The signal diagram 300 may optionally begin by training the large language model 138. In some embodiments, the machine learning training application 142 may train the machine learning model 140 and/or the large language model 138. In further embodiments, another computing entity may train the machine learning model 140 and/or the large language model 138. In yet further embodiments, the machine learning model 140 and/or the large language model 138 may be pretrained. In general, training the large language model 138 may include building or “teaching” the model to predict or determine certain outputs based upon certain inputs.

The signal diagram 300 may also optionally begin or continue from the indication 302 when the data extraction module 150 receives an indication 304 that the network node 110A is transmitting a network packet. For example, the network node 110A may be transmitting a network packet to the network node 110B. The data extraction module 150 may then receive the network packet 306 and proceed to extract data from the data payload in the network packet.

In some embodiments, the network packet may contain one or more images. The data extraction module may then transmit the one or more images 308 to the OCR tool 136. The OCR tool 136 may then extract any text contained in the one or more images as machine-readable text. The machine-readable text 310 may then be transmitted to the data extraction module 150. After receiving the machine-readable text 310, the data extraction module 150 may combine any remaining data in the data payload with the machine-readable text 310 into one body of text representing the entire content of data payload of the network packet 306. In some embodiments, the data extraction module 150 may tag the network packet 306 with a summary of the contents of the data payload.

The contents of the data payload 312 as a body of text may be transmitted to data contextualization module 152. At the data contextualization module 152, the extracted data may be contextualized to determine the level of sensitivity of the data. In some embodiments, the data contextualization module 152 may transmit the contents of the data payload 312 as data to be contextualized 314 and any contextual information 316 about the network packet 306 to the machine learning model 140.

After receiving the data to be contextualized 314 and the contextual information 316, the machine learning model 140 may determine a level of sensitivity of the data, along with an indication of detected sensitive data. The indication of detected sensitive data may include: (i) whether sensitive data was detected, (ii) the contents of the sensitive data, (iii) the type of sensitive data detected, and (iv) the location of the sensitive data within the data payload (e.g., a relative location, a page number, a document identifier, etc.). The machine learning model 140 may then transmit the level of sensitivity 318 and the indication of sensitive data 320 to the data privacy module 154. The machine learning model 140 or the data contextualization module 152 may tag the network packet 306 with the corresponding level of sensitivity 318 and indication of sensitive data 320.

It should be understood that any of contextualization steps as described above may additionally or alternatively be performed by the large language model 138. In some embodiments, for example, the data to be contextualized 318 may be transmitted to the large language model 138, and the large language model 138 may determine an indication of detected sensitive data. The large language model 138 may also transmit the indication of detected sensitive data to the machine learning model 140, where the machine learning model 140 may determine a level of sensitivity of the data.

In some embodiments, the contextual information 316 may be used to determine the level of sensitivity 318. For example, the machine learning model 140 may determine that a payload containing data stored on database 104 is a high level of sensitivity regardless of the sender and/or recipient of the data. As another example, the machine learning model 138 may determine that an email body has a low level of sensitivity if an intended recipient is a network node on the network 102 but has a high level of sensitivity if an intended recipient is a webpage accessible via the internet 162.

Following the contextualization of the data payload, the data privacy module 154 may then use the level of sensitivity 318 and indication of sensitive data 320 to perform a data security procedure 322. The data security procedure 322 may include taking appropriate actions to protect the privacy and security of any sensitive data contained in the data payload. In general, the data privacy module takes different actions in response to different levels of sensitivity. In response to a high level of sensitivity, the data privacy module may take steps to redact the identified sensitive data from the payload. In some embodiments, redacting the sensitive data may include deleting the portion of the data payload that contains sensitive data. In other embodiments, the deleted data may be replaced with placeholder data indicating the sensitive data was deleted.

In some embodiments, the data payload includes an image containing sensitive data, and the data privacy module 154 may redact sensitive data from the image by, for example, covering the areas of the image containing sensitive data with a black box, or deleting the image.

The data privacy module 154 may also identify a node on the network 102 that transmitted the network packet 306. The identified node, or origin node, may be identified by a corresponding IP address. In response to the identifying of the origin device or node, the data privacy module 154 may take actions to prevent the origin node from transmitting further network packets on the network 102. The data privacy module 154 may analyze new network packets transmitted on network 102 and drop all new packets originating from the detected node. The data privacy module 154 may also drop the network packet containing data payload to prevent data payload from being received by an intended recipient. The data privacy module 154 may also generate an alert to a system administrator and/or to a user associated with the origin node.

In additional or alternative embodiments, the method depicted by signal diagram 300 may include additional, alternative, or fewer elements and/or signals.

### Example Methods

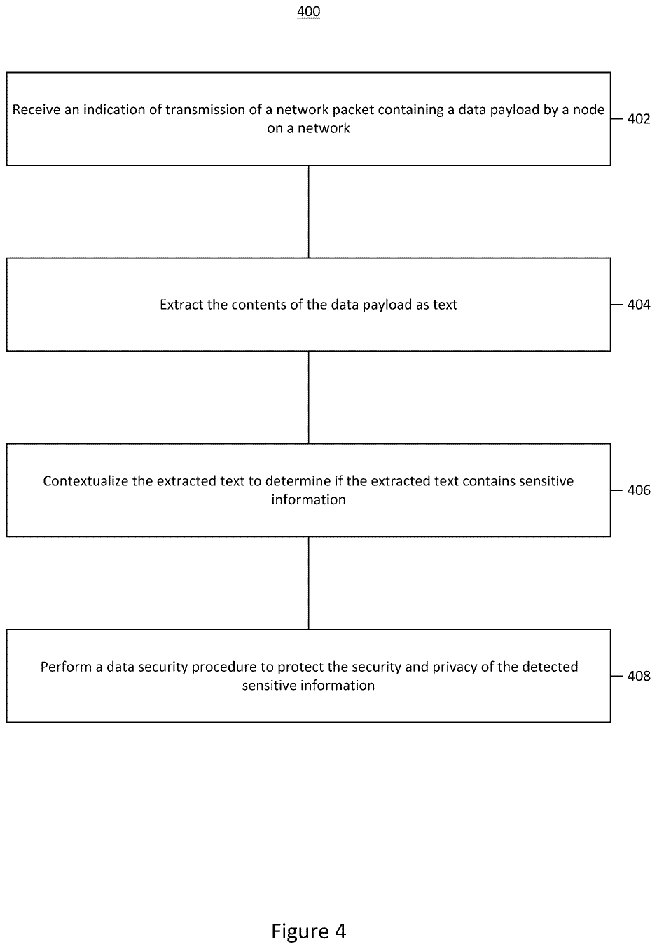

FIG. 4 depicts an exemplary method 400 for protecting data privacy and security in a network through contextual data discovery. The method 400 may be performed by the computing environment 100 depicted in FIG. 1 or any other components as described herein. The method 400 may include additional, alternate, or fewer blocks not depicted in FIG. 4. Similarly, it will be understood that the elements of method 400 may be performed in other orders as appropriate, and that alternate embodiments of the method may similarly change what elements are described as optional herein.

The method 400 may optionally begin at block 402, where the method 400 receives an indication of transmission of a network packet on a network, such as the network 102. The network node may contain a data payload corresponding to information that one node transmits to one or more other nodes on the network. In some embodiments, the indication may be sent from the node transmitting the network packet and received by the data security server 130. In other embodiments, the data security server 130 may analyze all network packets transmitted on the network and automatically receive an indication whenever any network packet is transmitted.

The node transmitting the network packet, which may be referred to as the origin node, may be any network node capable of communicating via the network, such as the network node 110A. The transmitted network packet may have one or more intended recipients, which may be referred to as the recipient node(s). The recipient node may be any network node capable of communicating via the network, such as the network node 110B, the database 104, or any node communicatively connected to the external network 160. In some embodiments, the recipient node may be connected to an external network and/or accessible via the internet 162.

At block 404, the contents of the data payload of the network packet may be extracted as text to be analyzed to determine if the data payload contains sensitive data. It should be understood that the network packet may contain data other than the data payload, such as metadata or headers used to assist with, for example, routing the network packet, that are not part of the data that the origin node intended to transmit.

At block 404, the data from the data payload may be extracted as machine-readable text. The data contained in the data payload contained of the transmitted network packet may be one of various categories of data, and the data may have various origins. Example categories of data may include, data stored on a database connected to the network, prompts sent to generative artificial intelligence (Gen AI) tools, information entered via webpage, information sent to a webserver, or an email body or attachment. Each of the various categories of data may include text, images, video, audio, or data in any format appropriate for transmittal in a network packet. The extraction of the various categories and types of data may utilize specific software programs as discussed herein.

For example, if the data payload contains one or more images, an OCR tool may be used to extract text embedded in an image. As another example, if the data payload is a proprietary file, such as a PDF file, a corresponding proprietary file type editing program (e.g., a PDF editing program) may be used to extract text from the file. Various programs may be combined to extract data from, for example, an image in a PDF file. Accordingly, the method at block 404 may use any appropriate software program to extract text from any file containing data that can be extracted as machine-readable text.

At block 406, the text extracted from the data payload may be contextualized. In some embodiments, the process of contextualizing the extracted text may be performed by a machine learning model, such as the machine learning model 140 and/or the large language model 138. Broadly speaking, the machine learning model may take input including the extracted data and contextual information about the network packet. The machine learning model may analyze the contents of the extracted text to detect whether the extracted text contains sensitive data. In some embodiments, the machine learning model may determine that the extracted text contains sensitive data if at least one of personally identifying information (PII) or confidential information is detected in the data payload.

In some embodiments, the large language model 138 may use the contextual information to categorize any detected sensitive data by a level of sensitivity. In some embodiments, the levels of sensitivity may be low, medium, and high. In further embodiments, the large language model 138 may determine that the data payload poses a data privacy and security risk in response to a high level of sensitivity categorization. The contextual information of the network packet may include, a user or device associated with the node that transmitted the network packet, one or more intended recipient nodes of the network packet, one or more users and/or devices associated with the one or more intended recipient nodes, and contents of the extracted text that do not contain sensitive data.

In some embodiments, the large language model 138 may output an indication of detected sensitive data and a level of sensitivity of the detected sensitive data. The indication of detected sensitive data may include, among other information: (i) whether sensitive data was detected, (ii) the contents of the sensitive data, (iii) the type of sensitive data detected, and (iv) the location of the sensitive data within the data payload (e.g., a relative location, a page number, a document identifier, etc.). The indication of detected sensitive data may be utilized by the machine learning model 140 to determine the level of sensitivity of the sensitive data, as the level of sensitivity may depend upon contextual information, such as the information contained in the indication.

Following the contextualization of the extracted data, at block 408, a security procedure may be performed. Based upon the contextualization of the data, the method 400 at block 408 may take various steps to protect the privacy and security of any detected sensitive data in the network packet. In some embodiments, the machine learning model 140 may determine, based upon the contextualization of the data, the security procedure to perform.

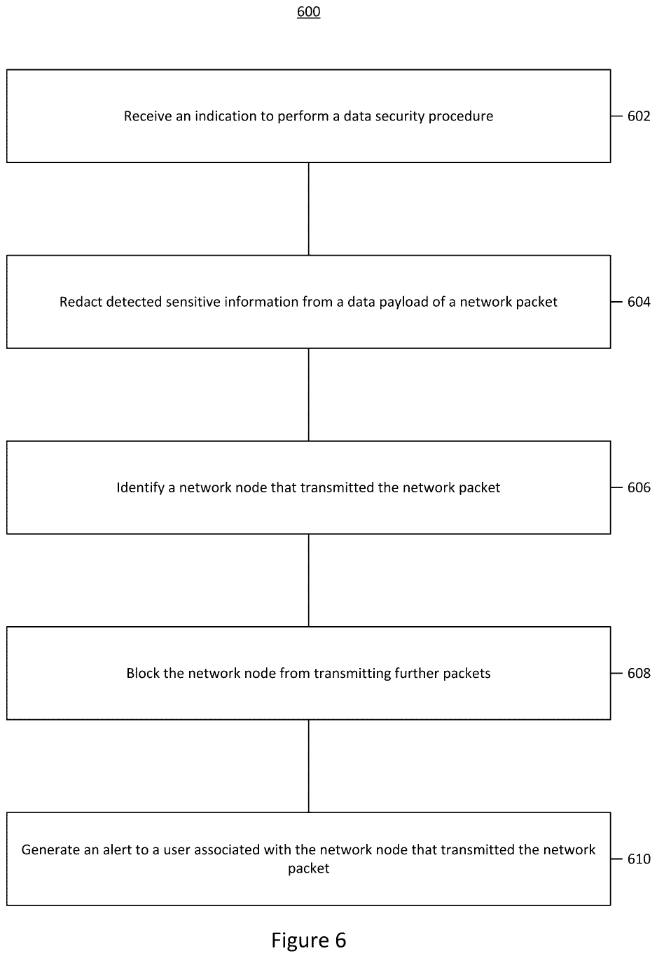

The method 400 at block 408 may redact any sensitive data from the network packet. To further protect the privacy and security of any detected sensitive data, the method 400 may also identify the node that transmitted the network packet and block the identified node from transmitting further network packets. The method 400 may also generate an alert. Further details regarding the method 400 at block 408 may be found herein, for example, with regard to FIG. 6.

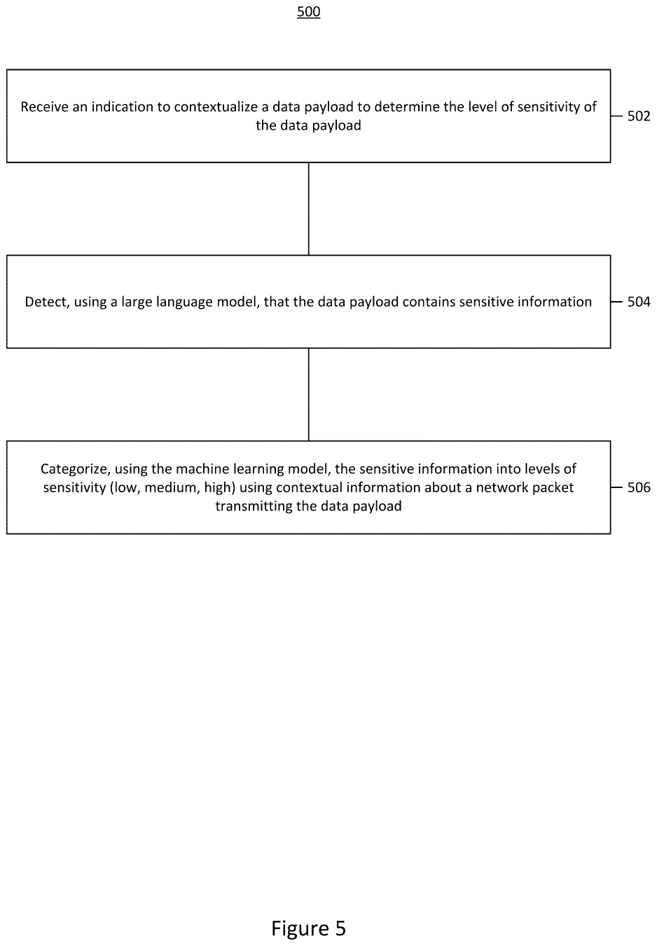

FIG. 5 depicts an exemplary method 500 for contextualizing data, for example, contained in a data payload of a network packet. In some embodiments, the method 500 may be performed by a machine learning model, such as the machine learning model 140. The method 500 may be performed by the computing environment 100 depicted in FIG. 1 or any other components as described herein. The method 500 may include additional, alternate, or fewer blocks not depicted in FIG. 5. Similarly, it will be understood that the elements of method 500 may be performed in other orders as appropriate, and that alternate embodiments of the method may similarly change what elements are described as optional herein.

The method 500 may optionally begin at block 502, where an indication to contextualize a body of text may be received. The indication may be received, for example, from block 406 of FIG. 4. In some embodiments, receiving the indication may include receiving a body of machine-readable text corresponding to data extracted from the data payload. The machine learning model may analyze the extracted text from the network packet.

At block 504, the large language model 138 may determine if the extracted text contains sensitive data. If sensitive data is detected, the large language model 138 may output an indication of the detected sensitive data. The indication may include: (i) whether sensitive data was detected, (ii) the contents of the sensitive data, (iii) the type of sensitive data detected, and (iv) the location of the sensitive data within the data payload (e.g., a relative location, a page number, a document identifier, etc.).

The indication may include whether the large language model detected sensitive data in the data payload. In some embodiments, the large language model may determine the data payload contains sensitive data if at least one of PII or confidential information was detected. The indication of whether sensitive data was detected may be a simple Boolean variable, such as true or false, 0 or 1, or yes or no. The indication of the contents of the sensitive data may correspond to the raw data that was detected to be sensitive. The indication of the type of sensitive data may correspond to one or more categories of data that is sensitive. The location of the sensitive data may indicate a location in the data payload where sensitive data is detected.

At block 506, the machine learning model 140 may contextualize the detected sensitive data and categorize the detected sensitive data into different levels of sensitivity. In some embodiments, the data payload may be categorized into one of three levels of sensitivity: low, medium, or high, where a high level of sensitivity may correlate to highly sensitive data. In some embodiments, alternative names and/or labels may be assigned to each of the levels, and the method at block 506 may categorize the extracted data into more or fewer levels of sensitivity.

In some embodiments, the categorization may be determined by analyzing the contents of the data payload and/or the contextual information about the network packet and data payload. Contextual information about the network packet may include any one of a user or device associated with a node that transmitted the network packet, one or more intended recipients of the network packet, a user or device associated with at least one of the one or more intended recipients, or contents of the data payload excluding the detected sensitive data. Other contextual information may include the method of transmission of the network packet, the timestamp of the transmission, historical network packet transmissions of a user or device associated with the network node, the type of network, the volume of traffic on the network, the type of organization associated with the network, among others.

In some embodiments, the method at block 506 may also determine, based upon the indication of detected sensitive data and contextualization of the data payload, if the data payload poses a data privacy and security risk. For example, a high level of sensitivity categorization of a data payload may result in a determination that the data payload poses a high data privacy and security risk.

As an illustrative example, at block 502, the method 500 may receive an indication to contextualize a data payload containing sensitive data, such as a phone number. The large language model 138 may detect that the data payload contains a phone number. The large language model 138 may transmit an indication of sensitive data indicating that (i) sensitive data was detected, (ii) the contents of the sensitive data are “123-456-7890,” (iii) the type of sensitive data is “personally identifiable information, phone number,” and (iv) the location of the sensitive data in the data payload is “line 1, column 1.” The machine learning model 140 may then determine, based upon contextual information, that the data payload is a high level of sensitivity, and poses a high data privacy and security risk.

FIG. 6 depicts an exemplary method 600 for performing a data security procedure, according to one embodiment. The method 600 may be performed by the computing environment 100 depicted in FIG. 1 or any other components as described herein. The method 600 may include additional, alternate, or fewer blocks not depicted in FIG. 6. Similarly, it will be understood that the elements of method 600 may be performed in other orders as appropriate, and that alternate embodiments of the method may similarly change what elements are described as optional herein

The method 600 may optionally begin at block 602 where an indication to perform the data security procedure may be received. For example, the indication may be received as described with regard to block 408 of FIG. 4. The method at blocks 604, 606, 608, and 610 may be parts of the data security procedure.

At block 604, sensitive data may be redacted. In general, the redaction step may include taking appropriate actions to ensure that sensitive data in a network packet is no longer visible by a human user and no longer accessible by a computing device. The redaction step may include receiving an indication of sensitive data, such as from the machine learning model in block 506 of FIG. 5. In particular, the redaction step may use the indication of the location of detected sensitive data in a data payload. In some embodiments, using the indication of the location of the detected sensitive data, the sensitive data may simply be deleted from the data payload.

In some embodiments, the method 600 at block 604 may also replace any redacted data with placeholder data indicating the type of data that was deleted. For example, the indication of detected sensitive data may indicate the sensitive data is a phone number. Accordingly, at block 604, the phone number may be deleted from the data payload and may be replaced with placeholder text “redacted phone number” or any other appropriate placeholder text.

The method at block 604 may be performed by a text-editing software module. In some embodiments, the data payload may be a data format other than text, and appropriate software tools may be used to redact the sensitive data. For example, if the data payload is an image, the method at block 604 may use an image-editing software module to delete, cover, or obfuscate the portion of the image containing sensitive data.

At block 606, a node that transmitted the network packet containing sensitive data may be identified. Identifying a node may include determining a unique identifier for the node, such as an IP address or a MAC address. Generally speaking, the node's identifying information may be found in the network packet, specifically, in the metadata or header section of the network packet. The method at block 606 may analyze the headers of the network packet to identify the source address field, to determine the IP address of the node that transmitted the network packet.

Following the identification of the node that originally transmitted the network packet containing sensitive data, at block 608, further network packets transmitted by the identified node may be blocked. The blocking step may include analyzing network packets transmitted on a network, and identifying all packets originating from the detected node, for example, by analyzing the metadata of all new network packets to determine the source address. The network may then drop (e.g., block, quarantine, delete, or otherwise prevent transfer of) at least a subset of the network packets originating from the detected node.

At block 610, an alert may be generated in response to the detection of sensitive data. The alert may include any information about the identified node, information about the method 600 at any step, and any information about the network packet. In some embodiments, the generated alert may also include information regarding steps taken in method 400 of FIG. 4 and method 500 of FIG. 5. The generated alert may include contextual information about the network packet, and/or the indication of detected sensitive data and the level of sensitivity of the network packet.

The alert may be generated at a single location or at multiple locations. In some embodiments, the alert may be generated at a computing device associated with the network node that transmitted the network packet. The generated alert may also be generated at a computing device of a user corresponding to the identified network node, either directly via the network node (e.g., displaying the alert on a GUI of the identified network node) or via some other method of communication with the user (e.g., phone, email, text, etc.). In some embodiments, the alert may be generated at a computing device associated with a system administrator of the network. In some embodiments, the user is a first user, and the generated alert may be transmitted to a second user associated with the identified network node or the first user. For example, the second user may be a manager or supervisor of the first user, and the generated alert may be transmitted to the second user.

It should be understood that the method 600 may perform any or all of the steps described by blocks 602-610. In some embodiments, the steps may be performed in response to a separate determination, such as a security level, and/or any other customizable settings.

### Example Machine Learning Techniques

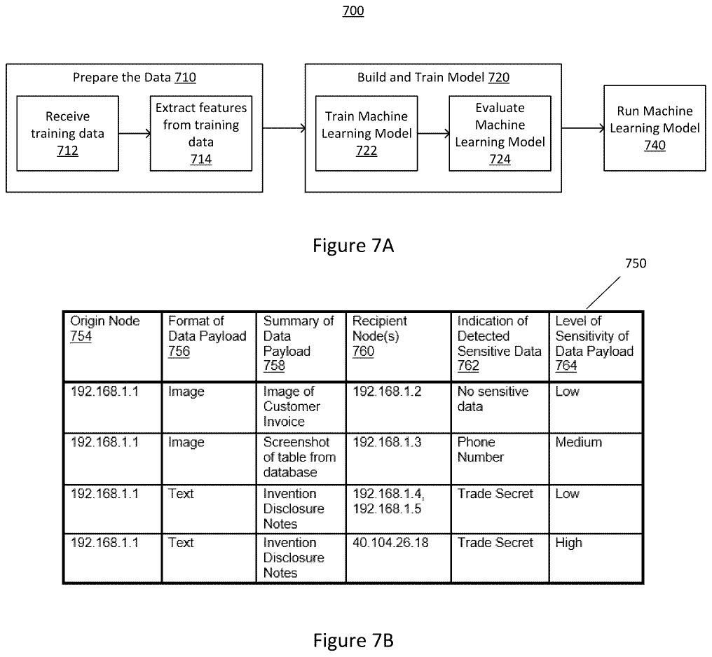

Generally speaking, the machine learning training application 142 may train a machine learning algorithm, such as the machine learning model 140 and/or the large language model 138, for example, to detect sensitive data and categorize detected sensitive data into levels of sensitivity based upon contextual information of the data. FIG. 7A depicts a block diagram of an example method of training and evaluating a machine learning model 700. In some embodiments, the machine learning model “learns” one or more algorithms capable of performing the desired function. It should be understood that the principles of FIG. 7A may apply to any machine learning algorithm and/or large language model discussed herein.

At a high level, the machine learning model 700 includes a block 710 to prepare the data, a block 720 to build and train the model, and block 740 to run the model. Block 710 may include sub-blocks 712 and 714. At sub-block 712, the machine learning training application 142 may receive historical data, or training data, to train the machine learning model 140. The training data generally correlates with data that a trained machine learning model will normally receive as input. In some embodiments, the training data may include historical network packets, historical contextual information about the historical network packets, indications of detected sensitive data corresponding to the historical network packets, and levels of sensitivity of the historical network packets. Specifically, the training data may include the following categories of data: (i) an identifier of the device that sent a network packet, (ii) the origin of data in the data payload of the packet, (iii) a summary of the contents of the data payload, (iv) unique identifier(s) of the intended recipient(s) of the network packet, (vi) an indication of any detected sensitive data, and (vi) a categorization of any sensitive data detected into levels of sensitivity.

In some embodiments, the machine learning model may be trained using the above elements (i)-(iv) as inputs to the machine learning model (also referred to as independent variables, or explanatory variables), and the above elements (v) and (vi) are the output of the machine learning model (also referred to as dependent variable, or response variable). Accordingly, values of the above elements (i)-(iv) may result in different values of the above elements (v) and (vi). The machine learning training application 142 may train a machine learning model to detect patterns and relationships between how different inputs affect the values of the outputs.

In some embodiments, the training data received at sub-block 712 may be organized in a table such as shown in FIG. 7B. The illustrated example contains data corresponding to the elements (i)-(vi) above: origin node 754, type of data payload 756, summary of data payload 758, recipient node(s) 760, indication of detected sensitive data 762, and level of sensitivity of data payload 764. It should be appreciated that table 750 depicts one example of a data structure associated with the historical information. In some instances, the machine learning training application 142 may receive training data in any alternate data structure that is appropriate for storing categorized data.

In some embodiments, the machine learning training application 142 may use additional, fewer, or alternative elements to train a machine learning model. For example, a new element, the raw data corresponding to the data payload may replace element (iii) summary of the data payload, when training a machine learning model.

In the table 750, the origin node 754 element may be an IP address corresponding to an origin node of the training data. It should be understood using an IP address to uniquely identify a node is only exemplary, as in other embodiments, additional or alternate methods of uniquely identifying a node may be used for the purposes of training the machine learning model.

The format of data payload 756 generally indicates how data in a data payload of a network packet transmitted by the origin node is formatted. Exemplary data formats may include text, image, audio, video, or any other data format that can be transmitted as a payload in a network packet.

The summary of data payload 758 may summarize the contents of the data payload. The summary may be generated by another Gen AI tool, like a large language model, or may be manually inputted into the training data.

The recipient node(s) 760 may be one or more IP addresses corresponding to one or more intended recipients of the network packet. It should be understood that use of an IP address to uniquely identify a node is only exemplary, as in other embodiments, additional or alternative methods of uniquely identifying a node may be used. In the table 750 of FIG. 7B, for illustrative purposes, IP addresses with the subnet starting with “192.168.1” refer to an internal network, while other subnets refer to external networks.

The indication of detected sensitive data 762 may include information about any sensitive data detected in the data payload. In some embodiments, the indication of detected sensitive data may include the same information as the indication of any detected sensitive data described in block 504 of FIG. 5. In Table 7B, the indication of detected sensitive data may be a set or array of data corresponding to (i) whether sensitive data is detected, (ii) the contents of the sensitive data, (iii) the type of sensitive data detected, and (iv) the location of the sensitive data within the data payload (e.g., a relative location, a page number, a document identifier, etc.). It should be noted that for the sake of illustration, table 750 of FIG. 7B may depict an abbreviated version of an indication used to train the machine learning model and may not depict the full indication of detected sensitive data. The level of sensitivity of data payload 764 may include a level of sensitivity, similar to that of block 506 in FIG. 5.

At sub-block 714, the machine learning training application 142 may extract features from the training data and organize the data into vector form. For example, the features may correspond to the values associated with the historical data used as input factors. Furthermore, at sub-block 714, the received data may be assessed and cleaned, including handling missing data and handling outliers. For example, missing records, zero values (e.g., values that were not recorded), incomplete data sets (e.g., for scenarios when data collection was not completed), outliers, and inconclusive data may be removed.

Blocks 720 may include sub-blocks 722 and 726. At sub-block 722, the machine learning model may be trained (e.g. based upon the data received from block 910). In some embodiments, training the machine learning model may involve optimizing a set of model parameters based upon a dataset to enable the model to recognize patterns and make predictions relating to the level of sensitivity of data and detecting sensitive data. The model may be implemented using various architectures, including but not limited to deep neural networks (DNNs), convolutional neural networks (CNNs), recurrent neural networks (RNNs), transformer-based models, or other machine learning frameworks. Training may be performed using supervised learning, unsupervised learning, semi-supervised learning, reinforcement learning, or a combination thereof.

In some embodiments, the machine learning model comprises multiple layers, such as an input layer, one or more hidden layers, and an output layer. The hidden layers may include fully connected layers, convolutional layers, pooling layers, normalization layers, attention layers, or recurrent units, each contributing to feature extraction, transformation, and decision-making. The training process may include forward propagation, where input data is passed through the model, and backpropagation, wherein gradients of a loss function are computed and used to update model parameters via optimization techniques such as stochastic gradient descent (SGD), Adam, RMSprop, or other gradient-based methods.

During training, various techniques may be applied to improve model accuracy and generalization, including dropout, batch normalization, data augmentation, and regularization methods such as L1 or L2 penalties. The model may be performed on dedicated hardware such as central processing units (CPUs), graphics processing units (GPUs), tensor processing units (TPUs), or other specialized accelerators. Additionally or alternatively, training may be conducted using a single machine or a distributed computing environment, such as a cloud-based platform or a federated learning system.

Broadly speaking, after training the machine learning model, the model may apply the one or more algorithms “learned” by the model to predict output variables for new sets of input variables. The machine learning model may apply the patterns, parameters, and layers “learned” drawn from the historical data and to predict output variables for new input data.

At block 724, the trained machine learning model may be evaluated to determine the accuracy of the model. The machine learning model may be evaluated using validation and test datasets to assess performance metrics such as accuracy, precision, recall, F1-score, or loss functions. Validation may be performed using a section of the historical data received. In some embodiments, the historical data may be split into two sections, one for training and one for evaluation. The machine learning model may also be evaluated by comparing historical results with predicted results.

At block 740, the machine learning training application 142 runs the trained machine learning model to predict an indication of detected sensitive data and a level of sensitivity of the sensitive data. Specifically, the machine learning model may receive input data corresponding to elements 754-760 formatted similarly to the training data and execute the one or more “learned” algorithms to predict the output data corresponding to elements 762-764.

In further embodiments (not depicted), the machine learning training application 142 may re-train a trained machine learning model. That is, the machine learning training application may repeat the training process on an already trained model. The benefits of re-training the model may include increasing the accuracy and speed of the trained model. Additionally, new training data that may be more representative of use cases of the trained model may be used during the re-training.

It would be clear to one of ordinary skill in the art that, in general, the prediction performed by a trained machine learning algorithm generally cannot be replicated by a rules-based algorithm or by manual (human) determination. During the training process of a machine learning model, the model may detect non-linear relationships and high-dimensional correlations within training data that may be difficult or impossible for a human to discern (and much less write an algorithm to take advantage of the relationships and correlations), thereby increasing the precision and robustness of the system. Additionally, the machine learning model may continuously improve performance through training on additional data, enabling the model to adapt to changing conditions or evolving input characteristics more effectively than static, rule-based approaches.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean...” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software code embodied on a non-transitory, tangible machine-readable medium or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed:

1. A computer-implemented method to protect data privacy and security in a network, the computer-implemented method comprising:
receiving, via one or more processors, an indication of transmission of a network packet by a node on the network;
extracting, by the one or more processors, a data payload contained in the network packet as text;
contextualizing, by the one or more processors and using a large language model, the extracted text to determine if the data payload poses a data privacy and security risk; and
in response to determining that the data payload poses a data privacy and security risk, performing, by the one or more processors, a data security procedure, the data security procedure including:
redacting sensitive data from the data payload,
identifying the node that transmitted the network packet; and
blocking the node from transmitting further packets.

2. The computer-implemented method of claim 1, wherein the data payload contains an image, and extracting the data payload as text further comprises:
using an OCR tool to extract text from the image.

3. The computer-implemented method of claim 1, wherein contextualizing the extracted text using a large language model to determine, the data payload poses a data privacy and security risk further comprises:
analyzing, by the large language model, contents of the extracted text;
detecting, by the large language model, that the extracted text contains sensitive data;
categorizing, by a machine learning model, the detected sensitive data into levels of sensitivity based upon the contents of the extracted text and contextual information of the network packet, the levels of sensitivity including: low, medium, and high; and
determining, by the machine learning model, that the data payload poses a data privacy and security risk in response to a high level of sensitivity categorization.

4. The computer-implemented method of claim 3, wherein detecting, using the large language model, that the extracted text contains sensitive data includes determining that the extracted text contains at least one of: personally identifiable information or confidential information.

5. The computer-implemented method of claim 3, wherein the contextual information of the network packet includes at least one of:
a user or device associated with the node;
an intended recipient node of the network packet,
a user or device associated with the intended recipient node, or contents of the extracted text other than the sensitive data.

6. The computer-implemented method of claim 5, wherein the intended recipient node is a node connected to an external network.

7. The computer-implemented method of claim 1, wherein further in response to determining that the data payload poses a data privacy and security risk:
generating, by the one or more processors, an alert on a computing device associated with the node that transmitted the network packet; or
generating, by the one or more processors, an alert on a computing device associated with a system administrator of the network.

8. The computer-implemented method of claim 1, wherein redacting the sensitive data from the network packet further includes:
replacing the redacted sensitive data with representative placeholder data.

9. The computer-implemented method of claim 1, wherein the data payload of the network packet is at least one of:
data stored on a database connected to the network;
prompts sent to generative artificial intelligence tools;
information entered via a webpage; or
an email body or attachment.

10. The computer-implemented method of claim 1, wherein in response to determining that the data payload does not pose a data privacy and security risk, transmitting, by the one or more processors, the node to one or more intended recipients.

11. A computing system to protect data privacy and security in a network, the computing system comprising:
one or more processors; and
non-transitory memory containing computer-executable instructions that when executed by the one or more processors, cause the computing system to:
receive an indication of transmission of a network packet by a node on the network;
extract a data payload contained in the network packet as text;
contextualize the extracted text using a large language model to determine if the data payload poses a data privacy and security risk; and
in response to determining that the data payload poses a data privacy and security risk, performing a data security procedure, the data security procedure including:
redact sensitive data from the data payload,
identify the node that transmitted the network packet; and
block the node from transmitting further packets.

12. The computing system of claim 11, wherein the data payload contains an image, and causing the computing system to extract the data payload as text further comprises:
using an OCR tool to extract text from the image.

13. The computing system of claim 11, wherein causing the computing system to contextualize the extracted text using a large language model to determine if the data payload poses a data privacy and security risk further causes the computing system to:
analyze, by the large language model, contents of the extracted text;
detect, by the large language model, that the extracted text contains sensitive data;
categorize, by a machine learning model, the detected sensitive data into levels of sensitivity based upon the contents of the extracted text and contextual information of the network packet, the levels of sensitivity including: low, medium, and high; and
determine, by the machine learning model, that the data payload poses a data privacy and security risk in response to a high level of sensitivity categorization.

14. The computing system of claim 13, wherein causing the computing system to detect, using the large language model, that the extracted text contains sensitive data includes causing the computing system to determine that the extracted text contains at least one of: personally identifying information or confidential information.

15. The computing system of claim 13, wherein the contextual information of the network packet includes at least one of:
a user or device associated with the node;
an intended recipient node of the network packet,
a user or device associated with the intended recipient node, or contents of the extracted text other than the sensitive data.

16. The computing system of claim 15, wherein the intended recipient node is a node connected to an external network.

17. The computing system of claim 11, wherein further in response to determining that the data payload poses a data privacy and security risk, causing the computing system to:
generate, by the one or more processors, an alert on a computing device associated with the node that transmitted the network packet; or
generate, by the one or more processors, an alert on a computing device associated with a system administrator of the network.

18. The computing system of claim 11, wherein causing the computing system to redact the sensitive data from the network packet further causes the computing system to:
replace the redacted sensitive data with representative placeholder data.

19. The computing system of claim 11, wherein the data payload of the network packet is at least one of:
data stored on a database connected to the network;
prompts sent to generative artificial intelligence tools;
information entered via a webpage; or
an email body or attachment.

20. A non-transitory computer-readable medium storing instructions that, when executed by one or more processors, cause the one or more processors to:
receive an indication of transmission of a network packet by a node on a network;
extract a data payload contained in the network packet as text;
contextualize the extracted text using a large language model to determine if the data payload poses a data privacy and security risk; and
in response to determining that the data payload poses a data privacy and security risk, performing a data security procedure, the data security procedure including:
redact sensitive data from the data payload,
identify the node on the network that transmitted the network packet; and
block the node from transmitting further packets.
